(19) United States
(12) Patent Application Publication
(10) Pub. No.: US 2012/0014547 A1
(43) Pub. Date: Jan. 19, 2012

(54) Hearing Instrument

(76) Inventors: Walter P. Sjursen, West Windsor, NJ (US); Michael DeSalvo, Princeton, NJ (US); Hassan A. Mohamed, Bayonne, NJ (US); Michael C. Pereira, Smithfield, RI (US); Daniel Nelsen, Warwick, RI (US); Son Luong, Cranston, RI (US); David Baker, Jamestown, RI (US); Thomas Stuart, North Attleboro, MA (US)

(21) Appl. No.: 12/806,197

(22) Filed: Nov. 3, 2009

(51) Int. Cl. H04R 25/00

(52) U.S. Cl. 381/323

(57) ABSTRACT

A hearing instrument may include an enclosure adapted for behind-the-ear placement that houses a microphone for converting an acoustical input signal to an electrical signal and a sound processing circuit for processing the electrical signal; an earpiece adapted for in-the-canal placement that includes a receiver for converting the processed electrical signal to an acoustical output signal; a replaceable battery housed in the enclosure for powering the microphone, sound processing circuit and receiver; and an electrical cable extending from the enclosure that electrically couples the processed electrical signal from the sound processing circuit to the receiver. The enclosure includes a top portion and a bottom portion. The top portion and the bottom portion pivot about a hinge point at one end of the enclosure to open and closed positions. In the open position, the battery is accessible for replacement. A latch mechanism at the other end of the enclosure secures the top portion to the bottom portion in the closed position. The bottom portion may be detached from the top portion and may be replaced by the user.

### BACKGROUND

In hearing instruments, battery replacement can be difficult for the user. Battery compartments are generally small and may be difficult to open. Once open, the battery compartment generally stays close to the body of the hearing instrument making it difficult for the user to grab the old battery, remove it, and replace it with a new battery. Battery compartments are generally delicate and may easily break if excessive force is applied. Also, hearing instruments may eventually become clogged with ear wax. In particular, for hearing instruments with the receiver in the canal, the receiver may become clogged with ear wax and the user may need to return the hearing instrument to a professional for service.

### SUMMARY

Therefore, it is desirable to have a hearing instrument in which the battery is easy to remove and replace, and in which the portion of the hearing instrument that may become clogged with ear wax or otherwise damaged is user replaceable.

An example hearing instrument may include an enclosure adapted for behind-the-ear placement that houses a microphone for converting an acoustical input signal to an electrical signal and a sound processing circuit for processing the electrical signal; an earpiece adapted for in-the-canal placement that includes a receiver for converting the processed electrical signal to an acoustical output signal; a replaceable battery housed in the enclosure for powering one or more of the microphone, sound processing circuit and receiver; and an electrical cable extending from the enclosure that electrically couples the processed electrical signal from the sound processing circuit to the receiver. The enclosure includes a top portion and a bottom portion. The top portion and the bottom portion pivot about a hinge point at one end of the enclosure to open and closed positions. The bottom portion may be detached from the top portion and may be replaced by the user.

In the open position of the enclosure, the battery is accessible for replacement. A latch mechanism at the other end of the enclosure secures the top portion to the bottom portion in the closed position.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a side perspective first embodiment of a hearing instrument.

FIG. 2 illustrates another side perspective view of the embodiment of FIG. 1 with the enclosure in an open position.

FIG. 3 illustrates a bottom perspective view of the embodiment of FIG. 1 with the bottom portion of the enclosure partially transparent.

FIG. 4 is an exploded view of an earpiece for the embodiment of FIG. 1.

FIG. 5 illustrates another perspective view of the embodiment of FIG. 1 with the top portion of the enclosure partially removed.

FIG. 6 illustrates another perspective view of the embodiment of FIG. 1 with the top portion of the enclosure partially removed and the enclosure in an open position.

FIG. 7 illustrates a bottom perspective view of the embodiment of FIG. 1 with the top portion of the enclosure partially removed and the enclosure in an open position.

FIG. 8 illustrates an embodiment of a circuit block diagram for a hearing instrument.

### DETAILED DESCRIPTION

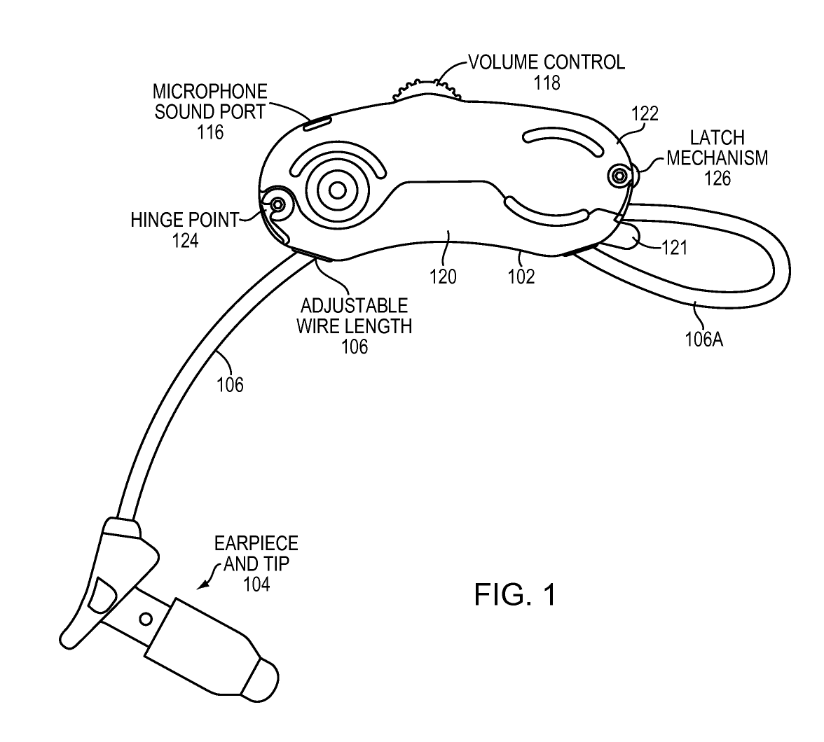

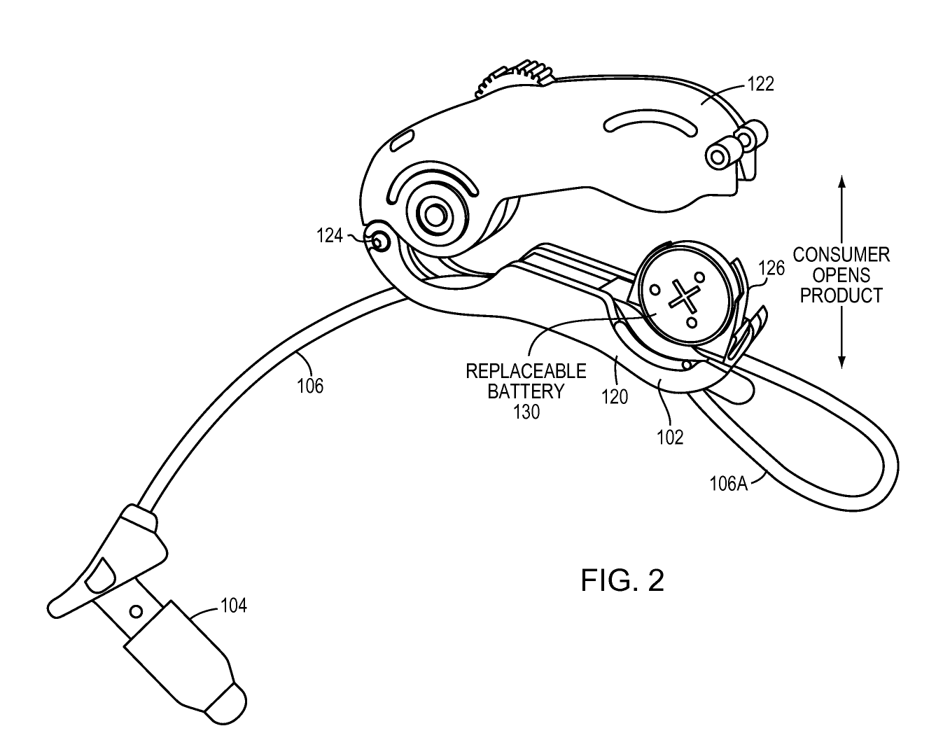

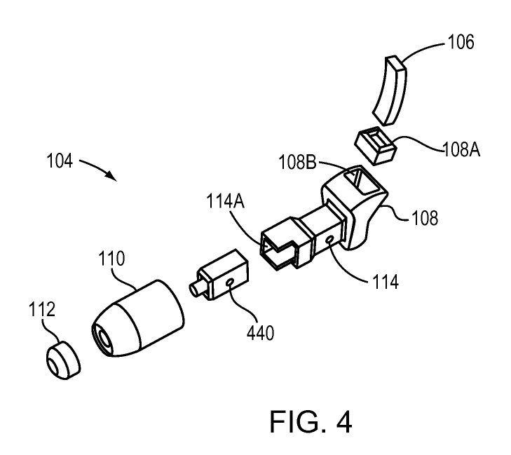

A first embodiment of a hearing instrument shown in FIG. 1 comprises an enclosure 102, an earpiece 104 and a cable 106. The enclosure 102 houses a microphone, sound processing circuitry, a battery 130 (shown in FIG. 2) and an on/off volume switch 118 that controls the gain of the microphone and the sound processing circuitry. The cable 106 connects signals from the enclosure 102 to a receiver (shown in FIG. 4) in the earpiece 104.

In an embodiment, the cable 106 runs through the body of the enclosure 102, and then loops back into the enclosure, forming a loop 106A. The cable 106 may be pulled through the enclosure 102 in either direction to either lengthen or shorten the distance between the enclosure and the earpiece 104. A stop 121 at one end of the enclosure 102 provides a minimum radius for the cable 106A and prevents the cable 106A from being pulled too far into the enclosure.

The cable 106 has electrical wires that may be molded into clear insulation, e.g., clear silicone. The wires may be stranded to provide flexibility and durability. In some embodiments, the wire gauge and stranding configuration may be selected to provide a measure of formability to accommodate forming the cable for sizing and user comfort. A clear insulation allows the skin tones to show through, thereby making the cable less visible. In some embodiments, rounded or other cross-sectional shapes may be used for the cable 106. Silicone is a good material to use since it is biocompatible and also provides sufficient friction against the skin to help prevent the hearing instrument enclosure 102 from sliding. In some embodiments, other insulation materials (including, but not limited to, polyvinyl chloride, polyurethane, or other thermoplastic elastomers) or colors may be used. Advantages of having adjustable length cabling are disclosed in U.S. patent application Ser. No. 12/147,113 filed Jun. 26, 2008,the entire contents of which are incorporated herein by reference.

The enclosure 102 may be made of a plastic or other light-weight material. The enclosure 102 is generally oblong in shape with a bottom portion 120 and top portion 122 joined at one end by hinge point 124 and removably secured together at the opposite end by latch mechanism 126.

Embodiments of the hearing instrument may be used on either the left or right ear. Since the cable 106 is flexible, the earpiece 104 may be twisted in the correct direction to be inserted into the ear. On the enclosure 102, an acoustical sound port 116 channels sound to the microphone. The sound port 116 may be located along a symmetrical or almost symmetrical axis to provide proper sound pickup regardless of which ear the hearing instrument is being worn on. Therefore, the same hearing instrument may be used for either ear.

FIG. 2 illustrates another side perspective view of the embodiment of FIG. 1 with the enclosure in an open position. The battery 130 can be a replaceable battery. In the open position, the top and bottom portions 122, 120 of the enclosure are unlatched at latch 126 and made to pivot about pivot point 124.

The top and bottom portions 122, 120 of the enclosure may open wide to provide the user easy access to the battery thereby providing ease of battery replacement. The bottom portion 120 may be detached from the top portion 122 at the pivot point 124 thereby providing the user the capability to replace the bottom portion 120 in the event it becomes damaged for example from excessive ear wax clogging the wax guard 112 or receiver 440.

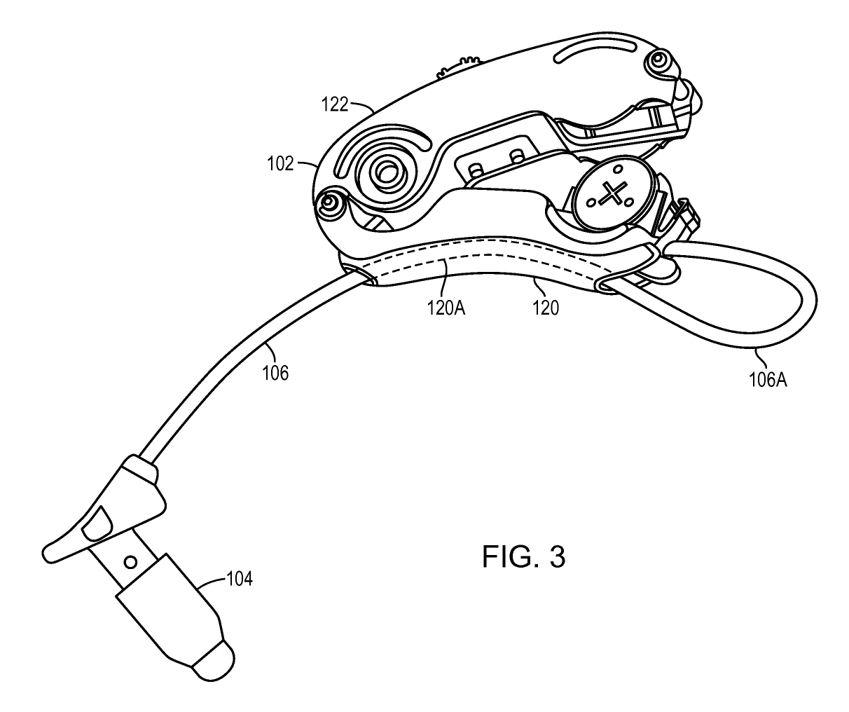

FIG. 3 illustrates a bottom perspective view of the embodiment of FIG. 1 with the bottom portion of the enclosure partially transparent to show how the cable 106 can slide through a channel 120A formed in the bottom portion 120 of the enclosure 102 to allow adjustment of the cable length. The channel 120A may be for example U-shaped or any other shape that guides the cable 106 through the bottom portion 120.

Referring now to FIG. 4, an exploded view of an example earpiece 104 is there shown. The earpiece 104 comprises a receiver 440, handle 108, tip 110, wax guard 112 and receiver holder 114. Receiver 440 may be mounted in opening 114A of receiver holder 114. The tip 110 may be made of a soft material, preferably silicon. An optional wax guard 112 made of reticulated foam may be attached to the tip 110. Other types of wax guards may be used. Cable 106 may be received through strain relief element 108A which fits in opening 108B of handle 108.

The handle 108 generally forms a T-shape with the receiver holder 114. The handle 108 and the receiver holder 114 may be made of plastic, for example acrylonitrile butadiene styrene (ABS). Other types of materials may be used. The surface of handle 108 may be curved to better conform to the shape of a user's finger and angled away from the tip to provide a measure of strain relief for the cable 106 that connects to the receiver through a top portion of the handle 108. In some embodiments, the connection between the cable 106 and the handle 108 may include a connector/receptacle configuration (e.g., an ultra-miniature electrical connector).

The handle 108 further provides a means for the user to insert the earpiece 104 to a proper and consistent depth within the ear canal. In particular, the handle 108 may be sized to prevent the tip 110 from touching the bony portion of the user's ear canal. Additionally, the handle 108 may prevent the user from inserting the tip 110 too deeply into the ear canal so as to avoid injury to the tympanic membrane.

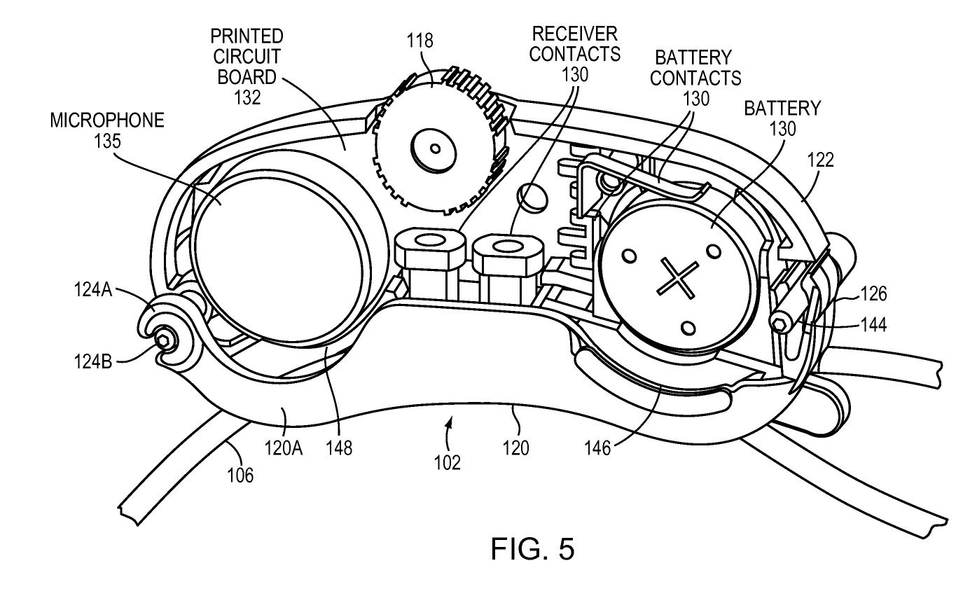

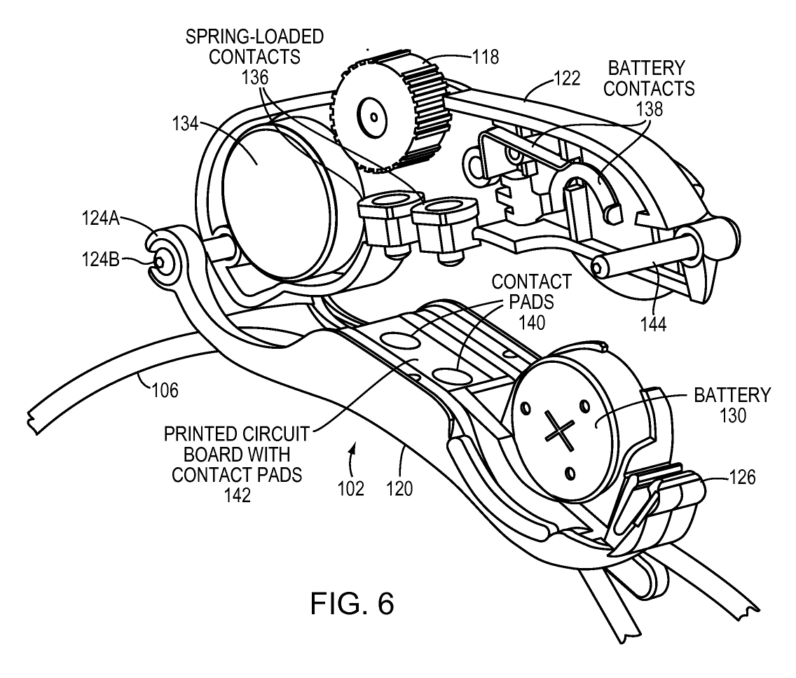

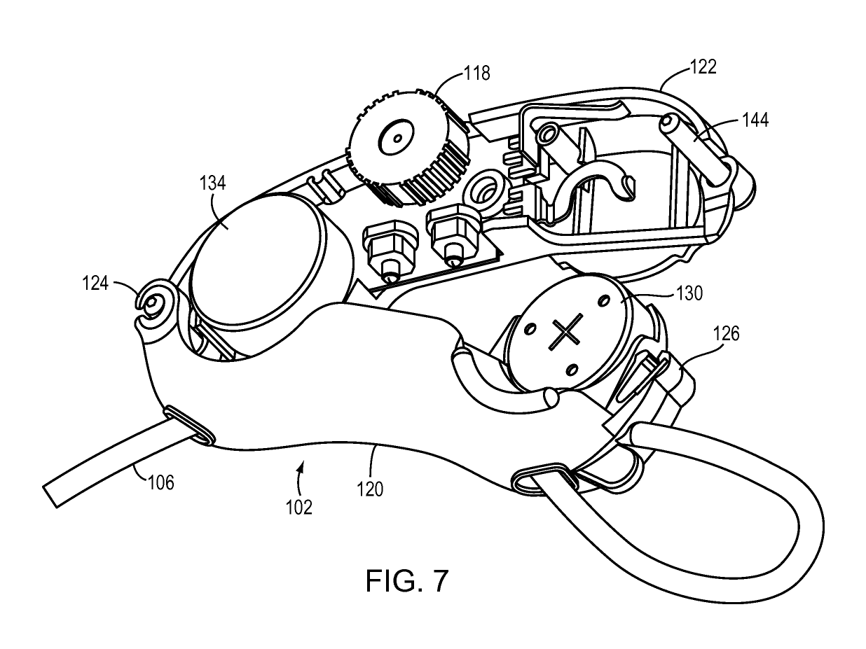

FIGS. 5 to 7 illustrate the embodiment of FIG. 1 with the top portion 122 of the enclosure 102 partially removed. FIG. 5 illustrates the closed position; FIGS. 6 and 7 illustrate the open position. With the top portion 122 partially removed, volume control 118, battery 130, sound processing printed circuit board 132 and microphone 134 can be seen. The battery 130 is mounted in a recess 146 in bottom portion 120. The microphone 134 is mounted to the sound processing board 132 in a recess 148 in top portion 122. The volume control 118 is mounted to the sound processing board 132 between the microphone 134 and battery 130. A pair of battery contacts 138 provides electrical connection between battery 130 and the printed circuit board 132. A pair of spring-loaded receiver contacts 136 provides electrical connection between the circuit board 132 and contact pads on a second printed circuit board 142 mounted on the bottom portion 120 which is in electrical communication with the receiver 440 (FIG. 4) through cable 106.

The pivot mechanism 124 is shown in more detail at one end of the enclosure 102 (FIG. 5). A curved arm 120A of bottom portion 120 includes a C-shaped section 124A that can pivot about a pin 1248 extending from the top portion 122.

At the other end of the enclosure 102, a pin 144 extending from the top portion 122 snaps into for example a V-shaped opening 126 on the bottom portion 120 to form the latch mechanism. The latch mechanism may be integral to the bottom portion 120. In another embodiment (not shown), the latch mechanism may be a separate piece, for example, made from metal and attached to the bottom portion 120. The latch mechanism may contain a detent feature to provide the user tactile feedback that the bottom portion 120 and top portion 122 are properly closed.

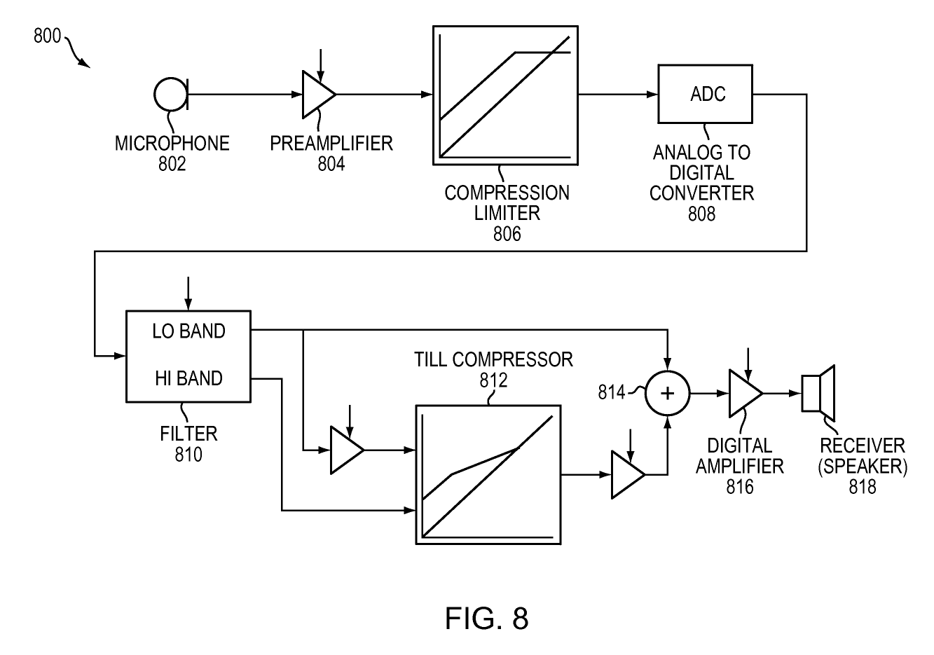

FIG. 8 shows an example circuit block diagram for use in any of the hearing instrument embodiments described herein. The hearing instrument circuit 800 includes a microphone 802, sound processing circuitry 804, 806, 808, 810, 812, 814, 816 and a receiver/speaker 818. A battery not shown supplies power to the circuitry 800. Sound is received by the microphone 802 and converted into an electrical signal. A preamplifier 804 amplifies the signal to appropriate levels within the circuit. The preamplifier 804 also has a programmable gain function and is programmed to compensate for tolerances in the microphone sensitivity. The signal then passes through a compression limiter circuit 806 that prevents loud sounds from overloading the circuit's signal path. Following the compression limiter 806 is an analog-to-digital converter (ADC) 808. While different types of ADCs may be used, some embodiments use a sigma-delta modulator based converter. The ADC 808 converts the analog signal into its digital representation. The digital signal then passes through a filter bank 810. In the embodiment shown, a two-band filter is employed. In other embodiments, the filter bank may use more than two filter bands. The outputs from the filter bank 810 pass through another compression circuit 812 that is configured to provide a Treble-Increase-at-Low-Levels (TILL) function. The output of the TILL compressor 812 is summed 814 with a fraction of the LO-band output from the filter bank 810, and then is processed by a digital amplifier 816. In an embodiment, the digital amplifier 816 is another sigma-delta modulator. This digital amplifier 816 also has programmable gain, used to compensate for tolerances of the receiver (speaker) sensitivity. The output of the digital amplifier 816 drives the receiver 818 that converts the digital signal back into sound.

More complex or less complex sound processing circuitry may be used with example embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A hearing instrument comprising:
an enclosure adapted for behind-the-ear placement that houses a microphone for converting an acoustical input signal to an electrical signal and a sound processing circuit for processing the electrical signal;
an earpiece adapted for in-the-canal placement that includes a receiver for converting the processed electrical signal to an acoustical output signal;
a replaceable battery housed in the enclosure for powering one or more of the microphone, sound processing circuit and receiver; and
an electrical cable that electrically couples the processed electrical signal from the sound processing circuit to the receiver.

2. The hearing instrument of claim 1 wherein the enclosure includes a top portion and a bottom portion, the top portion and the bottom portion adapted to pivot about a hinge point at one end of the enclosure to open and closed positions.

3. The hearing instrument of claim 2 further comprising a latch mechanism at the other end of the enclosure that secures the top portion to the bottom portion in the closed position.

4. The hearing instrument of claim 1 wherein the cable extends from the enclosure with an adjustable length and a portion of the cable is adjustably looped through the enclosure.

5. The hearing instrument of claim 2 wherein the bottom portion is detachable from the top portion.

6. The hearing instrument of claim 5 wherein the bottom portion is detachable at the hinge point.
